(19) United States
(12) Patent Application Publication
(10) Pub. No.: US 2026/0134436 A1
(43) Pub. Date: May 14, 2026

(54) INFORMATION PROCESSING APPARATUS, INFORMATION PROCESSING METHOD, AND INFORMATION PROCESSING PROGRAM

(71) Applicant: Propt Inc., Kanagawa (JP)

(72) Inventor: Naoki TSUKADA, Shinagawa-ku, Tokyo (JP)

(21) Appl. No.: 19/164,443

(22) PCT Filed: May 2, 2025
(86) PCT No.: PCT/JP2025/016571

§ 371 Date: Sep. 11, 2025

(30) Foreign Application Priority Data
Nov. 13, 2024 (JP) 2024-197853

(51) Int. Cl. G06Q 20/40

(52) U.S. Cl. CPC G06Q 20/407

(57) ABSTRACT

To provide an information processing apparatus for providing a cashless payment tool that can continuously provide benefits to both providers of the payment tool and customers who use the payment tool.

An information processing apparatus 60 includes a transaction information acquisition unit, a fee information acquisition unit, a cost information acquisition unit, a fee calculation unit, and a value calculation unit. The transaction information acquisition unit acquires transaction information including store information, payment tool identification information for identifying a payment tool used by a customer, and amount information that is information on a transaction amount from a transmission source of the transaction information. The fee information acquisition unit acquires information for calculating a fee paid to a provider that provides the payment tool to the customer due to use of the payment tool. The cost information acquisition unit acquires information indicating a processing cost for the provider to process the transaction. The value calculation unit calculates a value that can be returned to the customer based on the fee paid to the provider and the processing cost of the provider.

### TECHNICAL FIELD

The present invention relates to an information processing apparatus, an information processing method, and an information processing program.

### BACKGROUND ART

In recent years, various cashless payment tools that are highly convenient for users, such as credit cards, have become popular among consumers. When a user uses such a payment tool in making a payment at a store, the store pays a predetermined fee (a merchant fee) according to the transaction amount or the like to a payment operator or the like (an acquirer) that has concluded a merchant contract for the payment tool. The merchant fee is generally calculated based on the transaction amount and a merchant discount rate determined by a prior contract (e.g., a merchant contract) between each store and the acquirer.

The acquirer pays a predetermined shopping fee according to the transaction amount or the merchant fee to an operator (an issuer) that issues the credit card used by the user, and the shopping fee is a source of revenue for the issuer. The shopping fee is calculated as an interchange fee, for example, by multiplying the transaction amount by a predetermined percentage (IRF: interchange reimbursement fee) determined for each of the types of business of merchants or for each of the types of cards. Alternatively, the shopping fee is calculated in the form of revenue sharing of the merchant fee by multiplying the merchant fee calculated from the transaction amount and the merchant discount rate by a predetermined percentage. Note that transactions in which the operator of the acquirer is different from the operator of the issuer as mentioned above are called off-us transactions. On the other hand, transactions in which the operator of the acquirer is the same as the operator of the issuer are called on-us transactions. Since the issuer and the acquirer are the same payment operator in on-us transactions, the merchant fee earned by the payment operator as an acquirer is the shopping fee that is the revenue earned from the transaction by the payment operator that is an acquirer-cum-issuer.

### CITATION LIST

### Patent Literatures

Patent Literature 1: JP 2019-057138 A

### SUMMARY OF INVENTION

### Technical Problem

As mentioned above, the shopping fee that is a revenue of the issuer (that also acts as an acquirer in the case of on-us transactions) varies depending on the transaction amount of each transaction. On the other hand, most of the costs of the issuer are fixed costs that do not vary depending on transaction amounts, such as system costs, card issuance costs, labor costs, and costs for various member services. Therefore, for the issuer, high-value transactions with high transaction amounts also lead to high shopping fees, resulting in a surplus in the balance of payments, but low-value transactions with low transaction amounts also leads to low shopping fees, resulting in a deficit in the balance of payments. In recent years, with the spread of cashless payments, cashless payment tools have been used not only for high-value transactions as before but also for low-value transactions that occur on a daily basis. This causes a problem for issuers in that the increase in the proportion of low-value transactions that result in a deficit in the balance of payments deteriorates the business profit and loss of the issuers. Further, to avoid the above problem, issuers are forced to take measures, for example, reduce various services such as insurance, privileges, and points that have been provided to cardholders since joining (so-called worsening), or increase various fees related to card uses. This also causes a problem in that the decrease in the attractiveness of cards provided by issuers causes the withdrawal of members or the like, further deteriorating the business profit and loss of the issuers.

An object of the present invention, which has been made in view of the above circumstances, is to provide an information processing apparatus, an information processing method, and an information processing program for providing a cashless payment tool that can continuously provide benefits to both providers of the payment tool and customers who use the payment tool.

### Solution to Problem

An information processing apparatus includes a transaction information acquisition unit, a fee information acquisition unit, a cost information acquisition unit, a fee calculation unit, and a value calculation unit. The transaction information acquisition unit acquires transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction. The fee information acquisition unit acquires issuer fee information that is information for calculating an issuer fee paid to an issuer that provides the payment tool to the customer due to use of the payment tool in the transaction. The cost information acquisition unit acquires information indicating a processing cost for the issuer to process the transaction. The fee calculation unit identifies the issuer of the payment tool used in the transaction based on the payment tool identification information included in the transaction information, and calculates the issuer fee based on the issuer fee information of the identified issuer and the transaction information. The value calculation unit calculates a value that can be returned to the customer based on the issuer fee calculated by the fee calculation unit and the processing cost acquired by the cost information acquisition unit.

Further, an information processing apparatus includes a transaction information acquisition unit, a fee information acquisition unit, a cost information acquisition unit, a fee calculation unit, and a value calculation unit. The transaction information acquisition unit acquires transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction. The fee information acquisition unit acquires store fee information for calculating a store fee borne by the store in the transaction due to use of the payment tool in the transaction. The cost information acquisition unit acquires information indicating a processing cost for a provider that provides the payment tool to the store and the customer to process the transaction. The fee calculation unit calculates the store fee based on the store fee information acquired by the fee information acquisition unit and the transaction information. The value calculation unit calculates a value that can be returned to the customer based on the store fee calculated by the fee calculation unit and the processing cost acquired by the cost information acquisition unit.

An information processing method includes a transaction information acquisition step, a fee information acquisition step, a cost information acquisition step, a fee calculation step, and a value calculation step. In the transaction information acquisition step, transaction information is acquired from a transmission source of the transaction information, the transaction information including store information that is identification information of a store where a customer makes a transaction, payment tool identification information for identifying a payment tool used by the customer in the transaction, and amount information that is information on a transaction amount in the transaction. In the fee information acquisition step, issuer fee information that is information for calculating an issuer fee paid to an issuer that provides the payment tool to the customer due to use of the payment tool in the transaction is acquired. In the cost information acquisition step, information indicating a processing cost for the issuer to process the transaction is acquired. In the fee calculation step, the issuer of the payment tool used in the transaction is identified based on the payment tool identification information included in the transaction information, and the issuer fee is calculated based on the issuer fee information of the identified issuer and the transaction information. In the value calculation step, a value that can be returned to the customer is calculated based on the issuer fee calculated in the fee calculation step and the processing cost acquired in the cost information acquisition step.

Further, an information processing method includes a transaction information acquisition step, a fee information acquisition step, a cost information acquisition step, a fee calculation step, and a value calculation step. In the transaction information acquisition step, transaction information is acquired from a transmission source of the transaction information, the transaction information including store information that is identification information of a store where a customer makes a transaction, payment tool identification information for identifying a payment tool used by the customer in the transaction, and amount information that is information on a transaction amount in the transaction. In the fee information acquisition step, store fee information for calculating a store fee borne by the store in the transaction due to use of the payment tool in the transaction is acquired. In the cost information acquisition step, information indicating a processing cost for a provider that provides the payment tool to the store and the customer to process the transaction is acquired. In the fee calculation step, the store fee is calculated based on the store fee information acquired in the fee information acquisition step and the transaction information. In the value calculation step, a value that can be returned to the customer is calculated based on the store fee calculated in the fee calculation step and the processing cost acquired in the cost information acquisition step.

An information processing program is configured to cause a computer to function as the information processing apparatus described above.

### Effect of Invention

The information processing apparatus according to an embodiment of the present invention acquires information for calculating a fee paid to a provider that provides a payment tool to a customer. The information processing apparatus acquires information indicating a processing cost for the provider to process a transaction. The information processing apparatus identifies the provider of the payment tool used in the transaction based on the payment tool identification information included in the transaction information, and calculates a fee paid to the provider based on the fee information of the identified provider and the transaction information. The information processing apparatus calculates a value that can be returned to the customer based on the calculated fee of the provider and the acquired processing cost of the provider. This makes it possible to calculate a value that can be returned to the customer who made the transaction based on the profit in the transaction and the cost for the transaction for the provider that provides the payment tool used for the transaction. Therefore, it is possible to realize a cashless payment tool that can continuously provide benefits to both providers of the payment tool and customers who use the payment tool.

### BRIEF DESCRIPTION OF DRAWINGS

FIG. 1 is a diagram illustrating a schematic configuration of a payment system according to an embodiment of the present invention.

FIG. 2 is a block diagram illustrating a schematic configuration of a store terminal.

FIG. 3 is a block diagram illustrating a schematic configuration of an information processing center.

FIG. 4 is a block diagram illustrating a schematic configuration of an acquirer system.

FIG. 5 is a block diagram illustrating a schematic configuration of a payment brand system.

FIG. 6 is a block diagram illustrating a schematic configuration of an issuer system.

FIG. 7 is a block diagram illustrating a schematic configuration of an information processing apparatus.

FIG. 8 is a block diagram illustrating a functional configuration of the information processing apparatus.

FIG. 9 is a flowchart illustrating the procedure of a fee information acquisition process performed by the information processing apparatus.

FIG. 10 is a flowchart illustrating the procedure of a cost information acquisition process performed by the information processing apparatus.

FIG. 11 is a flowchart illustrating the procedure of a value calculation process performed by the information processing apparatus.

FIG. 12 is a diagram for illustrating an example of the value calculation process.

### DESCRIPTION OF EMBODIMENTS

An embodiment of the present invention will be described below with reference to the attached drawings. Note that in the description of the drawings, the same elements will be given the same reference numeral, and duplicate description will be omitted. Further, the dimensional ratios in the drawings may be exaggerated for the sake of description and differ from the actual ratios.

### (Payment System)

First, a payment system according to an embodiment of the present invention is described.

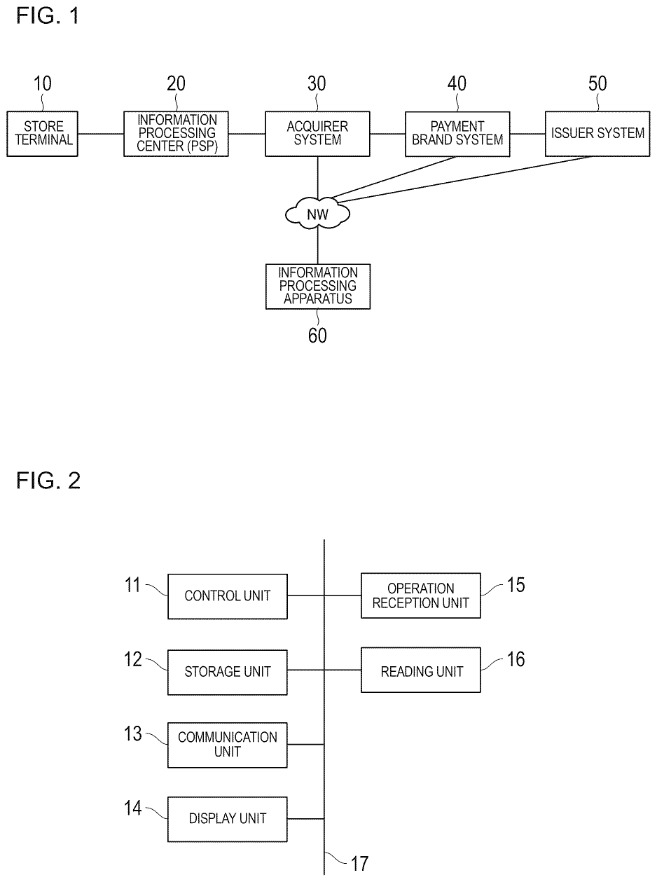

FIG. 1 is a diagram illustrating a schematic configuration of a payment system according to an embodiment of the present invention.

As shown in FIG. 1, the payment system includes a store terminal 10, an information processing center 20, an acquirer system 30, a payment brand system 40, an issuer system 50, and an information processing apparatus 60. The store terminal 10, the information processing center 20, the acquirer system 30, the payment brand system 40, the issuer system 50, and the information processing apparatus 60 are connected to each other via a network.

The store terminal 10 is an information terminal installed in a store as a merchant that uses the payment system. A plurality of store terminals 10 may be connected to a payment server via a network, and the payment server may be connected to the information processing center 20 and the like. In this case, the plurality of store terminals 10 and the payment server work together to form the store terminal 10. Further, when the store is a non-face-to-face merchant that makes non-face-to-face transactions such as Internet sales (EC), a payment server of the store or a payment server of a payment agency that performs payment processes in the store and a terminal such as a PC or a smartphone used by a customer work together to form the store terminal 10.

The information processing center 20 is a system for processing, transmitting, or receiving information related to payment. The information processing center 20 may include a system of a payment agency (PSP: payment service provider) that handles various processes related to payment on behalf. Alternatively, instead of the information processing center 20, the system of the payment agency may be connected as the PSP system 20. Further, the store terminal 10 may be connected to the acquirer system 30 over the network, not via the information processing center 20 (including the PSP system).

The acquirer system 30 is a system provided by an acquirer (a store contractor) that concludes a merchant contract with stores regarding the use of a payment tool. Note that when the acquirer has concluded a merchant contract with a payment agency, the store may conclude a merchant contract with the payment agency. In this case, the payment agency also acts as an acquirer for the store.

The payment brand system 40 is a system provided by a payment brand that operates a payment tool. Note that when the payment brand itself concludes a merchant contract with stores, the payment brand system 40 and the acquirer system 30 may be provided as the same system or as separate systems by the same operator.

The issuer system 50 is a system provided by an issuer that issues payment tools to users who are customers. As a payment tool issued by an issuer, for example, it is preferable to use a prepaid payment tool in which a user tops up their account with a value in advance and makes a payment using the value with which their account is topped up. Further, as a payment tool, a credit card payment tool that makes a deferred payment based on the user's credit may be used, or a debit card payment tool that immediately makes a withdrawal from the user's bank account to make a payment may be used. Note that when the payment brand itself issues a payment tool, the payment brand system 40 and the issuer system 50 may be provided as the same system or as separate systems by the same operator. Further, the payment brand itself may be an acquirer that concludes a merchant contract with stores. In this case, the payment brand system 40 and the acquirer system 30 may be provided as the same system, or may be provided as separate independent systems. Further, as described above, the issuer and the acquirer may be the same operator. In this case, the acquirer system 30 and the issuer system 50 may be provided as the same system, or may be provided as separate independent systems. The following will describe a case where the acquirer system 30, the payment brand system 40, and the issuer system 50 are independent systems, by way of example.

The information processing apparatus 60 is an apparatus for calculating a value (the number of points or the amount of a refund) returned to a customer in a transaction made by the customer at a store using a payment tool.

Note that although FIG. 1 shows an example in which the information processing apparatus 60 is connected to the acquirer system 30 and the issuer system 50, the present invention is not limited thereto. The information processing apparatus 60 may be connected to the store terminal 10, the information processing center 20, the payment brand system 40 and the like. Further, although the present embodiment describes a typical system configuration in credit card payment by way of example, the system configuration is changed as appropriate depending on the payment tool used or the like.

Next, the details of each constituent element will be described.

### (Store Terminal)

FIG. 2 is a block diagram illustrating a schematic configuration of the store terminal.

As shown in FIG. 2, the store terminal 10 includes a control unit 11, a storage unit 12, a communication unit 13, a display unit 14, an operation reception unit 15, and a reading unit 16. The components are communicably connected to each other via a bus 17.

The control unit 11 is a central processing unit (CPU), and performs control of the above components and various arithmetic processes according to programs.

The storage unit 12 comprises a read only memory (ROM) that stores various programs and various data in advance, a random access memory (RAM) that temporarily stores programs and data as a working area, a hard disk that stores various programs and various data, and the like.

The communication unit 13 is an interface for communicating with other terminals and apparatuses via a network. For example, the communication unit 13 transmits and receives various data and the like to and from the information processing center 20 and the like.

The display unit 14 comprises a liquid crystal display, a touch panel, or the like, and displays various types of information.

The operation reception unit 15 comprises a pointing device such as a mouse, a keyboard, a touch panel, or the like, and receives various operations from users. Note that the display unit 14 and the operation reception unit 15 may be formed integrally using a touch panel or the like.

The reading unit 16 reads and acquires payment tool identification information for identifying a payment tool used by a customer from the customer's card, the customer's information terminal, or the like. The reading unit 16 includes, for example, a contact or contactless card reader, and acquires payment tool identification information from a credit card or the like owned by a customer. The payment tool identification information includes, for example, information such as the card number and expiration date of the customer's credit card. The reading unit 16 may include a code reader that reads a code, for example, a one-dimensional code such as a barcode or a two-dimensional code such as a QR code (registered trademark). For example, in various code payments, the reading unit 16 acquires payment tool identification information by reading a barcode displayed on the customer's information terminal.

Note that when the store is a non-face-to-face merchant, a terminal such as a smartphone used by a customer may constitute the display unit 14, the operation reception unit 15, the reading unit 16, and the like. In this case, the reading unit 16 can acquire the payment tool identification information by acquiring information entered by the customer on a payment screen displayed on the display by browser software of a smartphone or the like.

### (Information Processing Center)

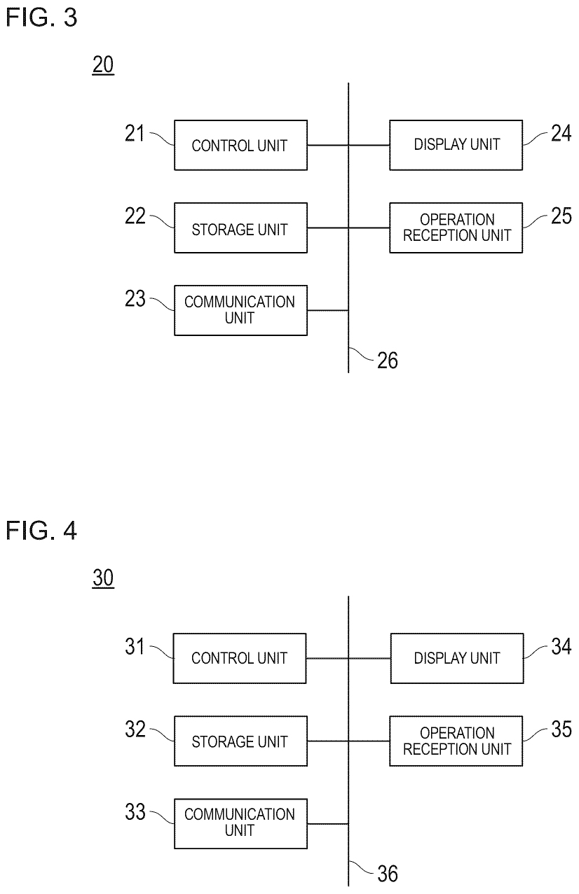

FIG. 3 is a block diagram illustrating a schematic configuration of the information processing center.

As shown in FIG. 3, the information processing center 20 includes a control unit 21, a storage unit 22, a communication unit 23, a display unit 24, and an operation reception unit 25. The components are communicably connected to each other via a bus 26. Note that since the components of the information processing center 20, which are the control unit 21, the storage unit 22, the communication unit 23, the display unit 24, and the operation reception unit 25, have functions similar to those of the components of the store terminal 10, which are the control unit 11, the storage unit 12, the communication unit 13, the display unit 14, and the operation reception unit 15, the description thereof is omitted.

### (Acquirer System)

FIG. 4 is a block diagram illustrating a schematic configuration of the acquirer system.

As shown in FIG. 4, the acquirer system 30 includes a control unit 31, a storage unit 32, a communication unit 33, a display unit 34, and an operation reception unit 35. The components are communicably connected to each other via a bus 36. Note that since the components of the acquirer system 30 have functions similar to those of the components of the information processing center 20, the detailed description is omitted.

### (Payment Brand System)

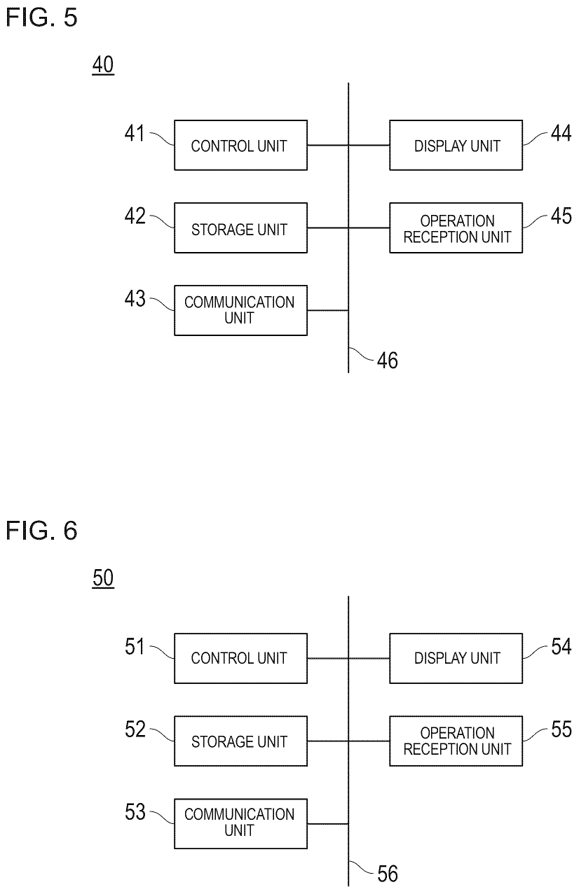

FIG. 5 is a block diagram illustrating a schematic configuration of the payment brand system.

As shown in FIG. 5, the payment brand system 40 includes a control unit 41, a storage unit 42, a communication unit 43, a display unit 44, and an operation reception unit 45. The components are communicably connected to each other via a bus 46. Note that since the components of the payment brand system 40 have functions similar to those of the components of the information processing center 20, the detailed description is omitted.

### (Issuer System)

FIG. 6 is a block diagram illustrating a schematic configuration of the issuer system.

As shown in FIG. 6, the issuer system 50 includes a control unit 51, a storage unit 52, a communication unit 53, a display unit 54, and an operation reception unit 55. The components are communicably connected to each other via a bus 56. Note that since the components of the issuer system 50 have functions similar to those of the components of the information processing center 20, the detailed description is omitted.

### (Information Processing Apparatus)

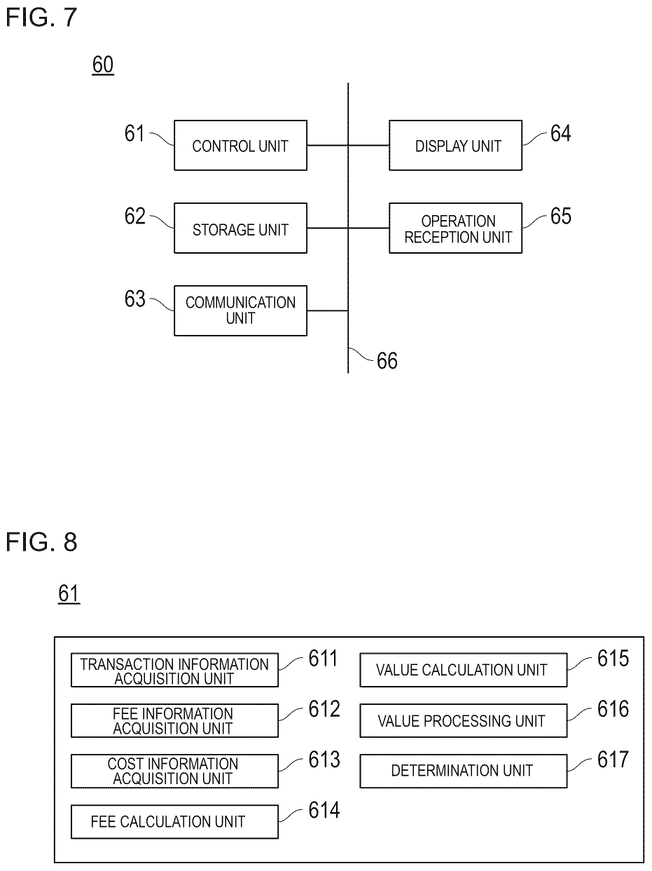

FIG. 7 is a block diagram illustrating a schematic configuration of the information processing apparatus.

As shown in FIG. 7, the information processing apparatus 60 includes a control unit 61, a storage unit 62, a communication unit 63, a display unit 64, and an operation reception unit 65. The components are communicably connected to each other via a bus 66. Note that since the components of the information processing apparatus 60 have functions similar to those of the components of the information processing center 20, the detailed description is omitted.

### (Functions of Information Processing Apparatus)

FIG. 8 is a block diagram illustrating a functional configuration of the information processing apparatus.

The control unit 61 of the information processing apparatus 60 reads a program stored in the storage unit 62 and performs processes. This causes the control unit 61 to function as a transaction information acquisition unit 611, a fee information acquisition unit 612, a cost information acquisition unit 613, a fee calculation unit 614, a value calculation unit 615, a value processing unit 616, and a determination unit 617, as shown in FIG. 8.

The transaction information acquisition unit 611 acquires transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction. The payment tool may be, for example, a prepaid payment tool that is topped up in advance and used by the customer.

The fee information acquisition unit 612 acquires issuer fee information that is information used to calculate an issuer fee paid to an issuer that provides the payment tool to the customer due to use of the payment tool in the transaction. The issuer fee information may be information indicating the percentage of the issuer fee to the transaction amount that is determined by a payment brand. Further, the issuer fee information may be set in such a way that the percentage of the fee paid to the issuer to the transaction amount varies depending on at least one of the payment brand, the type of business of the store, the type of the payment tool, the content or form of the transaction, the country of issue of the payment tool, and the contract status between the issuer of the payment tool and the store.

The cost information acquisition unit 613 acquires information indicating a processing cost for the issuer of the payment tool to process the transaction from the issuer.

The fee calculation unit 614 identifies the issuer of the payment tool used in the transaction based on the payment tool identification information included in the transaction information, and calculates the issuer fee based on the issuer fee information of the identified issuer and the transaction information.

The value calculation unit 615 calculates a value that can be returned to the customer based on the issuer fee calculated by the fee calculation unit 614 and the processing cost acquired by the cost information acquisition unit 613. The value calculation unit 615 calculates the value, for example, by subtracting the numerical value of the processing cost acquired by the cost information acquisition unit 613 from the numerical value of the fee calculated by the fee calculation unit 614.

The value processing unit 616 returns the value to the customer when the numerical value of the value calculated by the value calculation unit 615 is a positive numerical value, and collects the value from the customer when it is a negative numerical value. The value processing unit 616 may return the value to the customer as a grant of points or a refund.

The determination unit 617 determines whether a store contractor (an acquirer) that receives a store fee borne by the store in the transaction from the store is the same as or different from the issuer. When it is determined by the determination unit 617 that the store contractor is different from the issuer, the value calculation unit 615 calculates the value based on the issuer fee and the processing cost.

Alternatively, the fee information acquisition unit 612 may acquire store fee information for calculating a store fee borne by the store in the transaction due to use of the payment tool in the transaction. The store fee information may be, for example, information indicating a merchant discount rate determined by a store contractor (e.g., an acquirer or a payment agency that carries out business on behalf of the acquirer) in accordance with a merchant contract with the store. The merchant discount rate is, for example, the percentage of the store fee to the transaction amount. In this case, the cost information acquisition unit 613 acquires information indicating a processing cost for a provider (e.g., an acquirer and an issuer) that provides the payment tool to the store and the customer to process the transaction from the provider. Then, the fee calculation unit 614 calculates the store fee based on the store fee information acquired by the fee information acquisition unit 612 and the transaction information. The value calculation unit 615 calculates a value that can be returned to the customer based on the store fee calculated by the fee calculation unit 614 and the processing cost acquired by the cost information acquisition unit 613. For example, when the store contractor is the same as the issuer of the payment tool, the value calculation unit 615 calculates the value based on the store fee and the processing cost.

### (Overview of Processes)

The following describes processes performed by the information processing apparatus 60. Note that the following first describes a case of off-us transactions in which the operator of the acquirer is different from the operator of the issuer, by way of example. An example process in the case of on-us transactions in which the operator of the acquirer is the same as the operator of the issuer will be described later as a variant. Note that the information processing apparatus 60 can determine the operator that is the acquirer and the operator that is the issuer in the transaction using information such as the card number included in the payment tool identification information and a determination table stored in advance. The acquirer is a store contractor that receives a store fee borne by the store in the transaction from the store. The issuer is an issuer that has issued (provided) the payment tool used in the transaction to the customer. When the acquirer and the issuer are the same operator, the transaction is determined to be an on-us transaction, and when the acquirer and the issuer are different operators, the transaction is determined to be an off-us transaction.

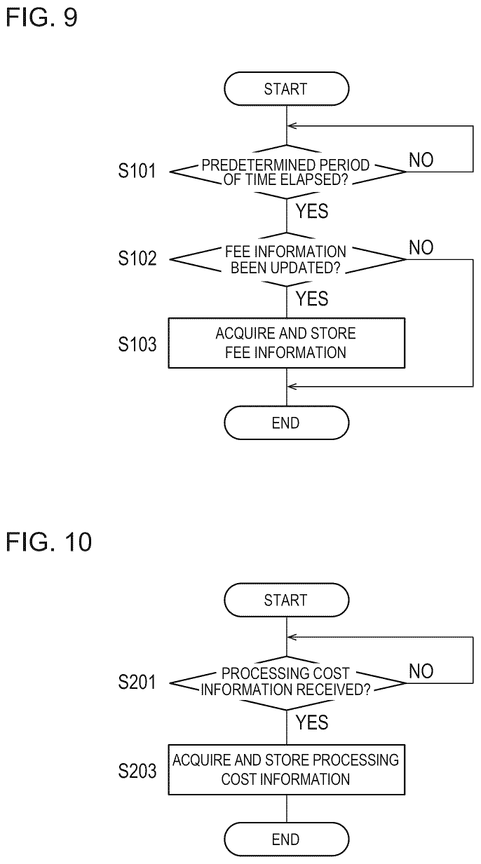

FIG. 9 is a flowchart illustrating the procedure of a fee information acquisition process performed by the information processing apparatus. The algorithm of the process shown in FIG. 9 is stored in the storage unit 62 of the information processing apparatus 60 as a program, and is executed by the control unit 61.

As shown in FIG. 9, the information processing apparatus 60 waits until a predetermined period of time has elapsed (step S101: NO), and when the predetermined period of time has elapsed (step S101: YES), it proceeds to the process in step S102. Any period of time such as one day or one week is set as the predetermined period of time according to the trend or frequency of updates of the issuer fee information or the like.

The information processing apparatus 60 determines whether the issuer fee information has been updated (step S102). For example, when the issuer fee is calculated based on the IRF as the interchange fee, the IRF is the issuer fee information. In that case, the information processing apparatus 60 accesses a database in the storage unit 42 of the payment brand system 40, a web page provided by the payment brand system 40, or the like to check the latest IRF. The IRF is, for example, information indicating the percentage of the issuer fee to the transaction amount according to the payment brand, the type of business of the store, the type of the payment tool, the content or form of the transaction, the country of issue of the payment tool, the contract status between the issuer of the payment tool and the store, and the like. The content or form of the transaction includes, for example, how the transaction is implemented, such as whether the transaction is a transaction made at the store using a payment tool each time or a transaction made continuously on a predetermined cycle using a payment tool registered under a contract. Further, the content or form of the transaction may also include items, such as whether the transaction is a transaction executed using a payment tool issued by the issuer or a transaction executed using various tokens like touch payment using a smartphone. Further, the content or form of the transaction may also include items, such as whether the store and the acquirer have generated sales data within a predetermined period of time after obtaining authorization of the credit transaction. Alternatively, when the issuer fee is calculated as a revenue share of the merchant fee, information indicating the merchant discount rate and the percentage paid to the issuer from the merchant fee is the issuer fee information. In that case, the information processing apparatus 60 accesses the acquirer system 30, the payment brand system 40, or the like to acquire information indicating the merchant discount rate and the percentage of the revenue share that are applied to the store. Note that the merchant discount rate and the percentage of the revenue share may also be changed depending on various factors, as in the case of the IRF above.

When the issuer fee information has not been updated (step S102: NO), the information processing apparatus 60 ends the process of acquiring the issuer fee information.

When the issuer fee information has been updated (step S102: YES), the information processing apparatus 60 acquires the latest issuer fee information and updates an issuer fee information table stored in the storage unit 62 (step S103). The information processing apparatus 60 ends the process of acquiring the issuer fee information. As a result, the latest issuer fee information is stored in the storage unit 62.

Note that although the above example has described an example of acquiring the issuer fee information only when the issuer fee information has been updated, the updating method is not limited thereto, and it is also possible to acquire and update the latest issuer fee information regardless of whether the issuer fee information has been updated or not. Further, when the issuer fee information has been updated, only the changed parts may be acquired and updated as differential data. Further, other information such as the determination table based on the card number provided by the payment brand may also be acquired together.

Further, the information processing apparatus 60 may acquire store master information in which various types of information about stores where transactions are made are recorded from the acquirer system 30 or the like. Information such as store information (e.g., a merchant number) for identifying each store, the type of business of the store, the name of the store, the merchant discount rate, and the payment cycle is stored in the store master information in association with each other. Further, the type of the payment terminal used in each store, the unit price of the transaction amount, various types of information related to fraudulent transactions, information on the PSP or payment network used, information on how to enter the payment tool identification information, and the like may be stored as the store master information.

FIG. 10 is a flowchart illustrating the procedure for a cost information acquisition process performed by the information processing apparatus. The algorithm of the process shown in FIG. 10 is stored in the storage unit 62 of the information processing apparatus 60 as a program and is executed by the control unit 61.

As shown in FIG. 10, the information processing apparatus 60 determines whether it has received a setting for processing cost information indicating a processing cost (step S201).

When a setting for the processing cost information have not been received (step S201: NO), the information processing apparatus 60 waits until it receives a setting for the processing cost information.

When a setting for the processing cost information has been received (step S201: YES), the information processing apparatus 60 stores the set processing cost information in the storage unit 62 (step S202). The processing cost information is, for example, information indicating the amount of a processing cost per transaction in each issuer. When there are a plurality of issuers, the processing cost information is set and stored for each issuer. The processing cost includes various costs for each issuer to provide a payment tool. For example, the processing cost may include system costs, card issuance costs, labor costs, costs for various membership services such as points, ancillary insurance, and promotional services, printing and postal costs, payment brand costs, fraud related costs, and the like. For example, the amount of a processing cost per transaction in each issuer is calculated from the processing cost for a certain period of time in each issuer and the number of transactions in that period of time. The information processing apparatus 60 receives a setting for the processing cost information, for example, from each issuer. Alternatively, the information processing apparatus 60 may receive a setting for the processing cost information, for example, from the operator that has calculated the processing cost based on information from each issuer.

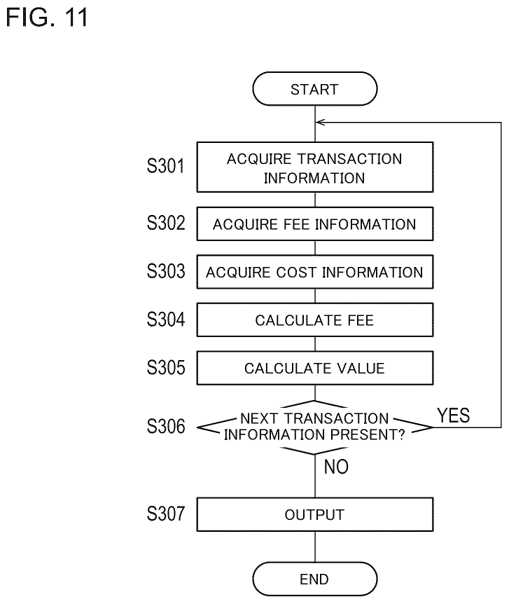

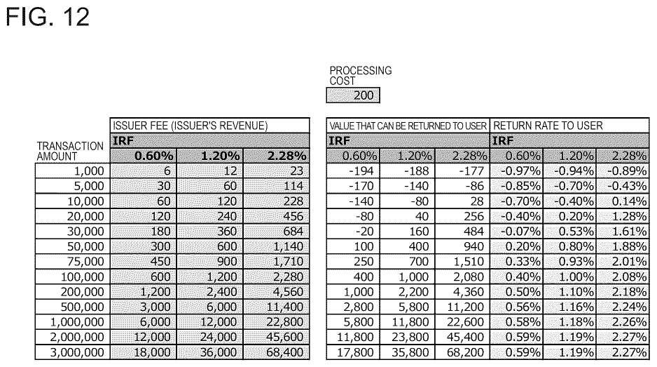

FIG. 11 is a flowchart illustrating the procedure of a value calculation process performed by the information processing apparatus. FIG. 12 is a diagram for illustrating an example of the value calculation process. The algorithm of the process shown in FIG. 11 is stored in the storage unit 62 of the information processing apparatus 60 as a program and is executed by the control unit 61.

As shown in FIG. 11, the information processing apparatus 60 acquires the transaction information (step S301). For example, the information processing apparatus 60 acquires the transaction information from the issuer system 50 according to a predetermined cycle, such as every day. Although the present embodiment describes an example of performing the value calculation process for each transaction, the present invention is not limited thereto, and the value calculation process may be performed collectively for a plurality of transactions to which the same conditions apply. The transaction information may include the store information, the payment tool identification information, transaction amount information, information indicating the content or form of the transaction, and the like.

Subsequently, the information processing apparatus 60 acquires the issuer fee information applied to the transaction based on the transaction information acquired in the process of step S301 (step S302). For example, the information processing apparatus 60 identifies the type of business of the store where the transaction was made based on the store information included in the transaction information and the store master stored in advance in the storage unit 62. Further, the information processing apparatus 60 identifies the payment brand of the payment tool used and the type of the payment tool based on the card number included in the transaction information as the payment tool identification information and the determination table stored in advance in the storage unit 62. Further, the information processing apparatus 60 also identifies the content or form of the transaction, the country of issue of the payment tool, contract information with the store, and the like based on the transaction information. The information processing apparatus 60 acquires the issuer fee information of the transaction by referring to the issuer fee information stored in the storage unit 62 based on the identified information.

Subsequently, the information processing apparatus 60 acquires the processing cost information of the issuer that has issued the payment tool used in the transaction by referring to the processing cost information of each issuer stored in the storage unit 62 (step S303).

Subsequently, the information processing apparatus 60 calculates the issuer fee in the transaction based on the transaction information acquired in the process of step S301 and the issuer fee information acquired in the process of step S302 (step S304). For example, the information processing apparatus 60 can calculate the issuer fee by applying the IRF or the merchant discount rate and the percentage of the revenue share acquired in the process of step S302 to the transaction amount.

Subsequently, the information processing apparatus 60 calculates a value that can be returned to the customer based on the issuer fee calculated in the process of step S304 and the processing cost acquired in the process of step S303 (step S305). FIG. 12 shows the relationship among the transaction amount, the issuer fee as the issuer's revenue, and the value that can be returned to the user as the issuer's revenue minus the processing cost. The range from 1,000 yen to 3,000,000 yen is shown as the transaction amount, three cases of 0.60%, 1.20%, and 2.28% are shown as the IRF, and 200 yen per case is set as the processing cost.

For example, when the transaction amount is 50,000 yen, the transaction with the IRF of 0.60% results in the issuer's revenue of 300 yen, and 100 yen obtained by excluding the processing cost of 200 yen is calculated as the value that can be returned to the user. The return rate to the user in this case is 0.20%. On the other hand, even when the transaction amount is the same, 50,000 yen, the transaction with the IRF of 2.28% results in the issuer's revenue of 1,140 yen, and 940 yen obtained by excluding the processing cost of 200 yen is calculated as the value that can be returned to the user. The return rate to the user in this case is a large numerical value of 1.88%.

Further, when the transaction amount is 200,000 yen, the transaction with the IRF of 0.60% results in the issuer's revenue of 1,200 yen, and 1,000 yen obtained by excluding the processing cost of 200 yen is calculated as the value that can be returned to the user. The return rate to the user in this case is 0.50%. On the other hand, even when the transaction amount is the same, 200,000 yen, the transaction with the IRF of 2.28% results in the issuer's revenue of 4,560 yen, and 4,360 yen obtained by excluding the processing cost of 200 yen is calculated as the value that can be returned to the user. The return rate to the user in this case is an even larger numerical value of 2.18%.

On the other hand, when the transaction amount is 1,000 yen, the transaction with the IRF of 0.60% results in the issuer's revenue of 6 yen, and when the processing cost of 200 yen is excluded, the value that can be returned to the user is calculated as a negative numerical value of −194 yen. Since the issuer's business profit or loss will be in the red in this case, the issuer collects a value equivalent to 194 yen from the user in order to continue the business. Further, even when the transaction amount is the same, 1,000 yen, the transaction with the IRF of 2.28% results in the issuer's revenue of 23 yen, and when the processing cost of 200 yen is excluded, the value that can be returned to the user is calculated as a negative numerical value of −177 yen. Since the issuer's business profit or loss will be in the red in this case, the issuer collects a value equivalent to 177 yen from the user in order to continue the business.

Note that when the value that can be returned to the user is a negative numerical value, the value may be collected from the user as described above, or simply nothing may be returned to the user without collecting the value from the user in consideration of the relationship with the user. Further, even when the value is collected from the user, various adjustments may be made, for example, by reducing the numerical value to be collected, or collecting nothing when certain conditions such as an average revenue per use are met.

Further, although the example in FIG. 12 has described a form of calculating the revenue of the issuer using the IRF by way of example, the process is also performed similarly in the form of revenue sharing of the merchant fee by subtracting the processing cost from the calculated revenue of the issuer.

Subsequently, the information processing apparatus 60 determines whether there is next transaction information to be processed (step S306).

When there is next transaction information to be processed (step S306: YES), the information processing apparatus 60 returns to the process of step S301 and repeats the processes of step S301 to step S305.

When there is no next transaction information to be processed (step S306: NO), the information processing apparatus 60 outputs the value that can be returned to the customer calculated in the process of step S305 (step S307). For example, the information processing apparatus 60 aggregates and outputs information indicating the numerical value of the calculated value in any unit such as per user or per account of the payment tool. For example, the information processing apparatus 60 may return the numerical value of the calculated value to the user as a grant of points or a refund. Further, the information processing apparatus 60 may output the calculated value by transmitting it to a pre-specified destination, such as the issuer system 50, the acquirer system 30, or the like. This allows the issuer or the like to appropriately grasp the numerical value of the value that can be returned to the user. The issuer may provide a return to the user by granting points equivalent to the amount of the value that can be returned to the user, or may provide a return to the user as a refund. Note that although the above embodiment has described an example of collectively acquiring and processing transaction information for a predetermined period of time, the present invention is not limited thereto. For example, the information processing apparatus 60 may calculate the value that can be returned to the user for each transaction, and output the calculated value so that the user can view it each time.

Although an example process in the payment system has been described above, the present invention is not limited only to the embodiment described above, but can be modified in various ways within the scope of the claims.

### (Variant)

Although the above embodiment has described a case of off-us transactions in which the operator of the acquirer is different from the operator of the issuer by way of example, a similar process is possible in the case of on-us transactions in which the operator of the acquirer is the same as the operator of the issuer. The following will give a detailed description.

Since the acquirer is the same as the issuer in on-us transactions, the issuer's revenue in the transaction can be regarded the same as the acquirer's revenue. The acquirer's revenue in the transaction is the merchant fee. Therefore, in on-us transactions, the information processing apparatus 60 uses a merchant discount rate (MDR), which is store fee information for calculating a store fee borne by the store in the transaction, instead of IRF. Further, in on-us transactions, the information processing apparatus 60 acquires and uses information indicating the amount of a processing cost per transaction in the acquirer as a processing cost in addition to the above-mentioned cost as an issuer. The processing cost of the acquirer may include system costs, payment terminal costs, labor costs, bank transfer fees, costs for various store services such as promotional services, printing and postal costs, payment brand costs, fraud related costs, and the like. For example, the amount of the processing cost per transaction in the acquirer is calculated from the processing cost for a certain period of time in the acquirer and the number of transactions in that period of time. The information processing apparatus 60 receives a setting for the processing cost information, for example, from an acquirer-cum-issuer that makes on-us transactions. Alternatively, the information processing apparatus 60 may receive a setting for the processing cost information, for example, from an operator that has calculated the processing cost based on information from the acquirer-cum-issuer.

Thus, in the case of on-us transactions, the information processing apparatus 60 acquires and stores the latest MDR by checking whether the MDR has been updated instead of the IRF in each of the processes in FIG. 9. Further, in the case of on-us transactions, the information processing apparatus 60 acquires and stores the processing cost information of the acquirer and the issuer in each of the processes in FIG. 10 instead of the processing cost of the issuer. In the case of on-us transactions, the information processing apparatus 60 acquires the MDR applied to a target transaction in the process of step S302 in FIG. 11, and acquires the processing cost of the acquirer-cum-issuer that processes the transaction in the process of step S303. Then, the information processing apparatus 60 calculates the merchant fee that is the revenue of the acquirer-cum-issuer in the process of step S304, and calculates the value that can be returned to the user by subtracting the processing cost from the merchant fee in the process of step S305.

Note that even in on-us transactions, when the issuer's revenue is clearly distinguished in the operator that is the acquirer-cum-issuer and the revenue as the issuer can be calculated based on the issuer fee information, the value that can be returned to the customer may be calculated based on the issuer fee and the processing cost of the issuer.

Although an example process in the payment system has been described above, the present invention is not limited only to the embodiment described above, but can be modified in various ways within the scope of the claims.

For example, although the above embodiment has described prepaid payment as a payment tool by way of example, the payment tool is not limited thereto. Payment tools include all payment tools such as debit card payment, prepaid card payment, electronic money payment, various code payments, various ID payments, convenience store payment, and deferred payment.

Further, stores include, as targets, face-to-face merchants that make face-to-face transactions by meeting customers and non-face-to-face merchants that make non-face-to-face transactions through various communication tools such as the Internet, telephone, and written documents without meeting customers.

Depending on the payment tool, the composition of operators or functional division in terms of the roles of the payment brand, the issuer of the payment tool, and the acquirer may differ from those in the embodiment and variant described above. For example, there are a case where the payment brand and the issuer of the payment tool are the same operator, a case where the payment brand and the acquirer are the same operator, a case where the acquirer and the issuer of the payment tool are the same operator, and the like. Even in such cases, applying the roles of the operators to the acquirer and the issuer allows applying the present invention in the same way as the above embodiment.

For example, in convenience store payment, a provider that provides a method of convenience store payment is also a payment brand, and is also an issuer that issues (provides) a payment tool to customers. Then, although there are also cases where the provider itself concludes merchant contracts with stores to become an acquirer, there are also many cases where a payment agency that can also collectively handle other payment tools concludes a merchant contract with the provider and the payment agency concludes merchant contracts with stores. In these cases, the payment agency is the acquirer in the present embodiment. Then, a fee paid by the payment agency to the provider, which is also the issuer, is the issuer fee. Therefore, even in the case of convenience store payment, the information processing apparatus 60 can calculate the value that can be returned to the user based on the issuer fee information and the processing cost information of the issuer. Further, when the issuer and the acquirer are the same operator, the information processing apparatus 60 can calculate the value that can be returned to the user based on the store fee information and the processing cost information of the issuer-cum-acquirer.

Further, the case of deferred payment is similar to the case of convenience store payment described above. A provider that provides a method of deferred payment is also a payment brand, and is also an issuer that issues (provides) a payment tool to customers. Then, when a payment agency concludes a merchant contract with the provider and the payment agency concludes merchant contracts with stores, the payment agency is the acquirer in the present embodiment. Therefore, even in the case of deferred payment, the information processing apparatus 60 can calculate the value that can be returned to the user based on the issuer fee information and the processing cost information of the issuer. Further, when the issuer and the acquirer are the same operator, the information processing apparatus 60 can calculate the value that can be returned to the user based on the store fee information and the processing cost information of the issuer-cum-acquirer.

Further, although the above embodiment has described an example in which the issuer fee information is a percentage that is set differently depending on the type of business of the store and the type of the payment tool, the present invention is not limited thereto. For example, as the issuer fee information, a flat percentage may be set, or a fixed amount may be set instead of a percentage. Furthermore, as the issuer fee information, the amount may be set in stages according to the range of the transaction amount, and any determination conditions or calculation formula may be set, such as a combination of such an amount and a percentage.

Further, the payment system may include apparatuses other than the store terminal 10, the information processing center 20, the acquirer system 30, the payment brand system 40, the issuer system 50, and the information processing apparatus 60, and may not include any of the constituent elements. Further, each of the store terminal 10, the information processing center 20, the acquirer system 30, the payment brand system 40, the issuer system 50, and the information processing apparatus 60 may include components other than the above components, and may not include some of the above components.

Further, the functions of each constituent element may be implemented by other constituent elements. For example, some of the functions described as those of the information processing apparatus 60 may be performed by other constituent elements, such as the information processing center 20, the acquirer system 30, the payment brand system 40, and the issuer system 50.

Further, the store terminal 10, the information processing center 20, the acquirer system 30, the payment brand system 40, the issuer system 50, and the information processing apparatus 60 may each be composed of a plurality of apparatuses or may be composed of a single apparatus.

Further, the processes in the billing support system according to the above embodiment may include steps other than those in the above flowcharts, or may not include some of the above steps. Further, the order of the steps is not limited to those in the above embodiment. Furthermore, each step may be combined with other steps and executed as a single step, may be included in other steps and executed, or may be divided into a plurality of steps and executed.

As described above, according to the information processing apparatus 60 of the present embodiment, transaction information including store information that is identification information of a store, payment tool identification information for identifying a payment tool used by a customer, and amount information that is information on a transaction amount is acquired from a transmission source of the transaction information. The information processing apparatus 60 acquires issuer fee information that is information for calculating an issuer fee paid to an issuer that provides the payment tool to the customer due to the use of the payment tool in the transaction. The information processing apparatus 60 acquires information indicating a processing cost for the issuer to process the transaction. The information processing apparatus 60 identifies the issuer of the payment tool used in the transaction based on the payment tool identification information included in the transaction information, and calculates the issuer fee based on the issuer fee information of the identified issuer and the transaction information. The information processing apparatus 60 calculates a value that can be returned to the customer based on the calculated issuer fee and the acquired processing cost. This makes it possible to calculate a value that can be returned to a customer who made a transaction based on the profit in the transaction for the issuer providing the payment tool used for the transaction and the cost for the transaction in the issuer. Therefore, it is possible to realize a cashless payment tool that can continuously provide benefits to both providers of the payment tool and customers who use the payment tool. The above configuration makes it possible to continuously provide benefits to both the operator of the issuer and customers, especially in off-us transactions where the acquirer is different from the issuer.

Further, the information processing apparatus 60 acquires transaction information from a transmission source of the transaction information, the transaction information including store information that is identification information of a store, payment tool identification information for identifying a payment tool used by a customer, and amount information that is information on a transaction amount. The information processing apparatus 60 acquires store fee information for calculating a store fee borne by the store in the transaction due to the use of the payment tool in the transaction. The information processing apparatus 60 acquires information indicating a processing cost for a provider that provides the payment tool to the store and the customer to process the transaction. The information processing apparatus 60 calculates a store fee based on the acquired store fee information and the transaction information. The information processing apparatus 60 calculates a value that can be returned to the customer based on the calculated store fee and the acquired processing cost. This makes it possible to calculate a value that can be returned to a customer who made a transaction based on the profit in the transaction for a provider that provides a payment tool used for the transaction and the cost for the transaction in the provider. Therefore, it is possible to realize a cashless payment tool that can continuously provide benefits to both providers of the payment tool and customers who use the payment tool. The above configuration makes it possible to continuously provide benefits to both the operator of the acquirer-cum-issuer and customers, especially in on-us transactions where the acquirer is the same as the issuer.

When customers use the payment tool to make a transaction that results in a large profit for the provider of the payment tool, such as a high-value transaction or a transaction at a store of a type of business in which the percentage of the provider's fee is high, the amount or percentage returned to them as points, a refund, or the like will increase according to the provider's profit. When providing the payment tool to a customer, the provider of the payment tool can use the information processing apparatus 60 of the present embodiment to appropriately calculate the value that can be returned to the customer for each transaction and then return points, a refund, or the like to the customer. Therefore, the provider of the payment tool can give customers a great incentive to make high-value transactions or transactions at high-fee stores, and can promote the use of the payment tool. In this way, according to the information processing apparatus 60 of the present embodiment, it is possible to continuously provide benefits to both the provider of the payment tool and customers who use the payment tool.

As described above, the fee that is a revenue of the provider of the payment tool varies depending on the transaction amount of each transaction. On the other hand, most of the costs of the provider of the payment tool are fixed costs that do not vary depending on the transaction amount, such as system costs and labor costs. Therefore, for the provider, high-value transactions with high transaction amounts also lead to high shopping fees, resulting in a surplus in the balance of payments, but low-value transactions with low transaction amounts also leads to low shopping fees, resulting in a deficit in the balance of payments. In recent years, with the spread of cashless payments, cashless payment tools have been used not only for high-value transactions as before but also for low-value transactions that occur on a daily basis. This causes a problem for providers that the increase in the proportion of low-value transactions that result in a deficit in the balance of payments deteriorates the business profit and loss. Further, to avoid the above problem, providers are forced to take measures, for example, reduce various services such as insurance, privileges, and points that have been provided to customers since joining (so-called worsening), or increase various fees related to card uses. This also causes a problem in that the decrease in the attractiveness of the payment tool causes the withdrawal of members or the like, further deteriorating the business profit and loss of the providers. According to the information processing apparatus 60 of the present embodiment, the profit and cost of the provider of the payment tool are identified for each transaction made using the payment tool to calculate the value that can be returned to the customer. Therefore, since it is possible to appropriately adjust the income and expenditure of the provider of the payment tool for each transaction as well as returning an appropriate value to the customer according to the profit, it is possible to continuously provide benefits to both the provider of the payment tool and customers who use the payment tool.

Further, the information processing apparatus 60 may calculate the value that can be returned to the customer by subtracting the numerical value of the acquired processing cost from the numerical value of the calculated fee. This makes it possible to realize a cashless payment tool that can continuously provide benefits to customers without difficulty to the extent that the provider of the payment tool suffers no loss.

Further, the information processing apparatus 60 may return the value to the customer when the numerical value of the calculated value is a positive numerical value, and collect the value from the customer when it is a negative numerical value. This makes it possible to realize a cashless payment tool that can continuously provide benefits to customers without difficulty to the extent that the provider of the payment tool suffers no loss. Further, when the numerical value of the value is negative, it is possible to discourage the customer from making transactions in which the profit of the provider of the payment tool is small by collecting the value from the customer, such as by subtracting points equivalent to the value from the customer. This can encourage customers to use the payment tool in transactions in which the provider's profit is high, thereby increasing the provider's profit and profit margin.

Further, the payment tool may be a prepaid payment tool that is topped up in advance and used by the customer. This eliminates the need for the provider of the payment tool to raise funds and pay on behalf of customers in order to allow them to pay later, to assess the customer's creditworthiness, solvency, and the like to provide credit, or to suffer losses on transactions that have become collectible. Therefore, the provider of the payment tool can reduce the risks and costs as mentioned above and thus reduce the processing costs required for transactions, thereby increasing the value that can be returned to customers more. Furthermore, since a prepaid payment tool can be used anonymously using only the identification information of the payment tool without associating it with the user's personal information, it is easy to issue and manage and can be widely used for gifts or the like. Further, a prepaid payment tool can also be used in a way that associates the user's personal information or bank account information with it and tops it up with a value from the bank account (e.g., tops it up based on user operations, or automatically tops it up based on balance conditions or the like). Therefore, it is possible to continuously provide significant benefits to both the provider of the payment tool and customers who use the payment tool.

Further, the information processing apparatus 60 returns the value to the customer as a grant of points or a refund. This allows the provider of the payment tool to return values to customers according to the profits in transactions in a way that is more straightforward and beneficial to customers.

Further, the issuer fee information is information indicating the percentage of the issuer fee to the transaction amount. In this way, for example, when the issuer fee is determined based on the IRF determined by the payment brand or the like, it is possible to easily identify the issuer fee and calculate the value that can be returned to the customer.

Further, the issuer fee information is set according to at least one of a payment brand that operates the payment tool, a type of business of the store, a type of the payment tool, a content or form of the transaction, a country of issue of the payment tool, and contract status between the issuer of the payment tool and the store. As a result, even when the issuer fee varies depending on the type of business of the store, the type of the payment tool, the content or form of the transaction, the country of issue of the payment tool, or the like, it is possible to calculate the value that can be returned to the customer using the issuer fee.

Further, the issuer fee information may be information indicating the percentage of the issuer fee to a merchant fee calculated based on the transaction amount and a predetermined merchant discount rate. As a result, for example, even when the issuer fee is determined using a method of revenue sharing of the merchant fee between the acquirer and the issuer at a predetermined ratio, it is possible to easily identify the issuer fee and calculate the value that can be returned to the customer.

Further, the information processing apparatus 60 determines whether a store contractor that receives a store fee borne by the store in the transaction is the same as or different from the issuer, and when it is determined that the store contractor is different from the issuer, calculates the value based on the issuer fee and the processing cost. As a result, in an off-us transaction where the acquirer is different from the issuer, it is possible to appropriately calculate the value that can be returned to the customer who made the transaction based on the profit of the issuer in the transaction and the cost for the transaction in the issuer.

Further, the information processing apparatus 60 determines whether a store contractor that receives a store fee borne by the store in the transaction from the store is the same as or different from the issuer, and when the store contractor is the same as the issuer of the payment tool, calculates the value based on the store fee and the processing cost. As a result, in an on-us transaction where the acquirer is the same as the issuer, it is possible to appropriately calculate the value that can be returned to the customer who made the transaction based on the profit of the operator of the acquirer-cum-issuer in the transaction and the cost for the transaction in the operator. The store fee information is information indicating the percentage of the store fee to the transaction amount. This makes it possible to, for example, easily identify the profit of the operator of the acquirer-cum-issuer in the transaction based on the merchant discount rate determined between the acquirer and the store or the like and calculate the value that can be returned to the customer.

Note that the means and methods for performing various processes in each apparatus of the system according to the above embodiment can be implemented by either a dedicated hardware circuit or a programmed computer. For example, the above program may be provided by a computer-readable recording medium such as a compact disc read only memory (CD-ROM), or may be provided online via a network such as the Internet. In this case, the program recorded on the computer-readable recording medium is usually transferred to and stored in a storage unit such as a hard disk. Further, the above program may be provided as standalone application software or may be incorporated in software for each apparatus of the system as a function of that apparatus.

Note that the following clauses are also included in the scope of the present invention:

Clause 1: An information processing apparatus comprising:
a transaction information acquisition unit that acquires transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction;
a fee information acquisition unit that acquires issuer fee information that is information for calculating an issuer fee paid to an issuer that provides the payment tool to the customer due to use of the payment tool in the transaction;
a cost information acquisition unit that acquires information indicating a processing cost for the issuer to process the transaction;
a fee calculation unit that identifies the issuer of the payment tool used in the transaction based on the payment tool identification information included in the transaction information, and calculates the issuer fee based on the issuer fee information of the identified issuer and the transaction information; and
a value calculation unit that calculates a value that can be returned to the customer based on the issuer fee calculated by the fee calculation unit and the processing cost acquired by the cost information acquisition unit.

Clause 2: An information processing apparatus comprising:
a transaction information acquisition unit that acquires transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction;
a fee information acquisition unit that acquires store fee information for calculating a store fee borne by the store in the transaction due to use of the payment tool in the transaction;
a cost information acquisition unit that acquires information indicating a processing cost for a provider that provides the payment tool to the store and the customer to process the transaction;
a fee calculation unit that calculates the store fee based on the store fee information acquired by the fee information acquisition unit and the transaction information; and
a value calculation unit that calculates a value that can be returned to the customer based on the store fee calculated by the fee calculation unit and the processing cost acquired by the cost information acquisition unit.

Clause 3: The information processing apparatus according to clause 1 or 2, wherein the value calculation unit calculates the value by subtracting a numerical value of the processing cost acquired by the cost information acquisition unit from a numerical value of the fee calculated by the fee calculation unit.

Clause 4: The information processing apparatus according to any one of clauses 1 to 3, further comprising a value processing unit that returns the value to the customer when a numerical value of the value calculated by the value calculation unit is a positive numerical value, and collects the value from the customer when the numerical value is a negative numerical value.

Clause 5: The information processing apparatus according to any one of clauses 1 to 4, wherein the payment tool is a prepaid payment tool that is topped up in advance and used by the customer.

Clause 6: The information processing apparatus according to clause 4, wherein the value processing unit returns the value to the customer as a grant of a point or a refund.

Clause 7: The information processing apparatus according to any one of clauses 1 and 3 to 6, wherein the issuer fee information is information indicating a percentage of the issuer fee to the transaction amount.

Clause 8: The information processing apparatus according to any one of clauses 1 and 3 to 7, wherein the issuer fee information is set according to at least one of a payment brand that operates the payment tool, a type of business of the store, a type of the payment tool, a content or form of the transaction, a country of issue of the payment tool, and contract status between the issuer of the payment tool and the store.

Clause 9: The information processing apparatus according to any one of clauses 1 and 3 to 6, wherein the issuer fee information is information indicating a percentage of the issuer fee to a merchant fee calculated based on the transaction amount and a predetermined merchant discount rate.

Clause 10: The information processing apparatus according to any one of clauses 1 and 3 to 9, further comprising a determination unit that determines whether a store contractor that receives a store fee borne by the store in the transaction from the store is the same as or different from the issuer, wherein when it is determined by the determination unit that the store contractor is different from the issuer, the value calculation unit calculates the value based on the issuer fee and the processing cost.

Clause 11: The information processing apparatus according to any one of clauses 2 to 6, further comprising
a determination unit that determines whether a store contractor that receives a store fee borne by the store in the transaction from the store is the same as or different from an issuer that provides the payment tool to the customer,
wherein when the store contractor that receives the store fee borne by the store in the transaction from the store is the same as the issuer of the payment tool, the value calculation unit calculates the value based on the store fee and the processing cost.

Clause 12: The information processing apparatus according to clause 2 or 11, wherein the store fee information is information indicating a percentage of the store fee to the transaction amount.

Clause 13: An information processing method performed by a computer, the information processing method comprising:
a transaction information acquisition step of the computer acquiring transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction;
a fee information acquisition step of the computer acquiring issuer fee information that is information for calculating an issuer fee paid to an issuer that provides the payment tool to the customer due to use of the payment tool in the transaction;
a cost information acquisition step of the computer acquiring information indicating a processing cost for the issuer to process the transaction from the issuer;
a fee calculation step of the computer identifying the issuer of the payment tool used in the transaction based on the payment tool identification information included in the transaction information, and calculating the issuer fee based on the issuer fee information of the identified issuer and the transaction information; and a value calculation step of the computer calculating a value that can be returned to the customer based on the issuer fee calculated in the fee calculation step and the processing cost acquired in the cost information acquisition step.

Clause 14: An information processing method performed by a computer, the information processing method comprising:
a transaction information acquisition step of the computer acquiring transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction;
a fee information acquisition step of the computer acquiring store fee information for calculating a store fee borne by the store in the transaction due to use of the payment tool in the transaction;
a cost information acquisition step of the computer acquiring information indicating a processing cost for a provider that provides the payment tool to the store and the customer to process the transaction from the provider;
a fee calculation step of the computer calculating the store fee based on the store fee information acquired in the fee information acquisition step and the transaction information; and
a value calculation step of the computer calculating a value that can be returned to the customer based on the store fee calculated in the fee calculation step and the processing cost acquired in the cost information acquisition step.

Clause 15: An information processing program for causing a computer to function as the information processing apparatus according to any one of clauses 1 to 12.

This application is based on the Japanese patent application filed on Nov. 13, 2024 (Japanese Patent Application No. 2024-197853), the disclosed content of which is incorporated herein by reference in its entirety.

### REFERENCE SIGNS LIST

10 Store terminal
11 Control unit
12 Storage unit
13 Communication unit
14 Display unit
15 Operation reception unit
16 Reading unit
20 Information processing center (PSP system)
21 Control unit
22 Storage unit
23 Communication unit
24 Display unit
25 Operation reception unit
26 Bus
30 Acquirer system
31 Control unit
32 Storage unit
33 Communication unit
34 Display unit
35 Operation reception unit
36 Bus
40 Payment brand system
41 Control unit
42 Storage unit
43 Communication unit
44 Display unit
45 Operation reception unit
46 Bus
50 Issuer system
51 Control unit
52 Storage unit
53 Communication unit
54 Display unit
55 Operation reception unit
56 Bus
60 Information processing apparatus
61 Control unit
611 Transaction information acquisition unit
612 Fee information acquisition unit
613 Cost information acquisition unit
614 Fee calculation unit
615 Value calculation unit
616 Value processing unit
617 Determination unit
62 Storage unit
63 Communication unit
64 Display unit
65 Operation reception unit
66 Bus

1. An information processing apparatus comprising:
a transaction information acquisition unit that acquires transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction;
a fee information acquisition unit that acquires issuer fee information that is information for calculating an issuer fee paid to an issuer that provides the payment tool to the customer due to use of the payment tool in the transaction;
a cost information acquisition unit that acquires information indicating a processing cost for the issuer to process the transaction;
a fee calculation unit that identifies the issuer of the payment tool used in the transaction based on the payment tool identification information included in the transaction information, and calculates the issuer fee based on the issuer fee information of the identified issuer and the transaction information; and
a value calculation unit that calculates a value that can be returned to the customer based on the issuer fee calculated by the fee calculation unit and the processing cost acquired by the cost information acquisition unit.

2. An information processing apparatus comprising:
a transaction information acquisition unit that acquires transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction;
a fee information acquisition unit that acquires store fee information for calculating a store fee borne by the store in the transaction due to use of the payment tool in the transaction;
a cost information acquisition unit that acquires information indicating a processing cost for a provider that provides the payment tool to the store and the customer to process the transaction;
a fee calculation unit that calculates the store fee based on the store fee information acquired by the fee information acquisition unit and the transaction information; and
a value calculation unit that calculates a value that can be returned to the customer based on the store fee calculated by the fee calculation unit and the processing cost acquired by the cost information acquisition unit.

3. The information processing apparatus according to claim 1, wherein the value calculation unit calculates the value by subtracting a numerical value of the processing cost acquired by the cost information acquisition unit from a numerical value of the fee calculated by the fee calculation unit.

4. The information processing apparatus according to claim 1, further comprising a value processing unit that returns the value to the customer when a numerical value of the value calculated by the value calculation unit is a positive numerical value, and collects the value from the customer when the numerical value is a negative numerical value.

5. The information processing apparatus according to claim 1, wherein the payment tool is a prepaid payment tool that is topped up in advance and used by the customer.

6. The information processing apparatus according to claim 4, wherein the value processing unit returns the value to the customer as a grant of a point or a refund.

7. The information processing apparatus according to claim 1, wherein the issuer fee information is information indicating a percentage of the issuer fee to the transaction amount.

8. The information processing apparatus according to claim 1, wherein the issuer fee information is set according to at least one of a payment brand that operates the payment tool, a type of business of the store, a type of the payment tool, a content or form of the transaction, a country of issue of the payment tool, and contract status between the issuer of the payment tool and the store.

9. The information processing apparatus according to claim 1, wherein the issuer fee information is information indicating a percentage of the issuer fee to a merchant fee calculated based on the transaction amount and a predetermined merchant discount rate.

10. The information processing apparatus according to claim 1, further comprising
a determination unit that determines whether a store contractor that receives a store fee borne by the store in the transaction from the store is the same as or different from the issuer,
wherein when it is determined by the determination unit that the store contractor is different from the issuer, the value calculation unit calculates the value based on the issuer fee and the processing cost.

11. The information processing apparatus according to claim 2, further comprising
a determination unit that determines whether a store contractor that receives a store fee borne by the store in the transaction from the store is the same as or different from an issuer that provides the payment tool to the customer,
wherein when the store contractor that receives the store fee borne by the store in the transaction from the store is the same as the issuer of the payment tool, the value calculation unit calculates the value based on the store fee and the processing cost.

12. The information processing apparatus according to claim 11, wherein the store fee information is information indicating a percentage of the store fee to the transaction amount.

13. An information processing method performed by a computer, the information processing method comprising:
a transaction information acquisition step of the computer acquiring transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction;
a fee information acquisition step of the computer acquiring issuer fee information that is information for calculating an issuer fee paid to an issuer that provides the payment tool to the customer due to use of the payment tool in the transaction;
a cost information acquisition step of the computer acquiring information indicating a processing cost for the issuer to process the transaction from the issuer;
a fee calculation step of the computer identifying the issuer of the payment tool used in the transaction based on the payment tool identification information included in the transaction information, and calculating the issuer fee based on the issuer fee information of the identified issuer and the transaction information; and
a value calculation step of the computer calculating a value that can be returned to the customer based on the issuer fee calculated in the fee calculation step and the processing cost acquired in the cost information acquisition step.

14. An information processing method performed by a computer, the information processing method comprising:
a transaction information acquisition step of the computer acquiring transaction information from a transmission source of the transaction information, the transaction information including store information that is identification information of a store where a customer makes a transaction, payment tool identification information for identifying a payment tool used by the customer in the transaction, and amount information that is information on a transaction amount in the transaction;
a fee information acquisition step of the computer acquiring store fee information for calculating a store fee borne by the store in the transaction due to use of the payment tool in the transaction;
a cost information acquisition step of the computer acquiring information indicating a processing cost for a provider that provides the payment tool to the store and the customer to process the transaction from the provider,
a fee calculation step of the computer calculating the store fee based on the store fee information acquired in the fee information acquisition step and the transaction information; and
a value calculation step of the computer calculating a value that can be returned to the customer based on the store fee calculated in the fee calculation step and the processing cost acquired in the cost information acquisition step.

15. (canceled)
